(19) United States
(12) Patent Application Publication
(10) Pub. No.: US 2024/0394901 A1
(43) Pub. Date: Nov. 28, 2024

(54) METHOD AND APPARATUS, DEVICE, AND STORAGE MEDIUM FOR IMAGE GENERATION

(71) Applicant: Beijing Zitiao Network Technology Co., Ltd., Beijing (CN)

(72) Inventor: Lijie LIU, Beijing (CN)

(21) Appl. No.: 18/696,889

(22) PCT Filed: Sep. 14, 2022
(86) PCT No.: PCT/CN2022/118670

§ 371 Date: Mar. 28, 2024

(30) Foreign Application Priority Data
Sep. 29, 2021 (CN) 202111151607.6

(51) Int. Cl. G06T 7/33; G06T 3/40; G06T 5/50; G06T 5/60; G06T 7/11; G06T 11/60

(52) U.S. Cl. CPC G06T 7/337; G06T 3/40; G06T 5/50; G06T 5/60; G06T 7/11; G06T 11/60; G06T 2207/20081; G06T 2207/20132; G06T 2207/20221; G06T 2207/30196

(57) ABSTRACT

Embodiments of the disclosure discloses a method, apparatus, device and storage medium for image generation. The method includes obtaining a first human body image comprising a target human body and a first clothing image comprising target clothing; performing key point extraction, portrait segmentation and human body part segmentation on the first human body image respectively, to obtain a key point feature image, portrait segmented image and human body part segmented image; inputting the key point feature image, the portrait segmented image, human body part segmented image and first clothing image into a transformation model, to obtain a transformed second clothing image; and inputting the second clothing image, first human body image, key point feature image, portrait segmented image and human body part segmented image into a merging model, to obtain a second human body image, wherein the target human body in the second human body image wears the target clothing.

The application claims the priority to Chinese Patent Application No. 202111151607.6, filed with the China Patent Office on Sep. 29, 2021, the entirety of which is incorporated herein by reference.

### FIELD

Embodiments of the present disclosure relate to the technical field of image processing, for example, to a method, apparatus, device, and storage medium for image generation.

### BACKGROUND

With the development of science and technology, more and more application software has entered user lives, gradually enriching the users' spare time life, such as short video APPs, etc. Users can record their lives by means of videos, photos, etc., and upload them to the short video APPs.

There are many effects based on image algorithms and rendering techniques on the short video APPs, wherein virtual clothing changing refers to the application of image fusion technology to fuse a user's human body image with a clothing image comprising target clothing to obtain an image of the user wearing the target clothing, so that the user can know the wearing effect of the target clothing without actually trying on the target clothing.

At present, an image fusion model is usually applied to extract features from the human body image and the clothing image respectively in the process of virtual clothing changing. A new image is generated based on the two extracted image features, i.e., the image of the user wearing the target clothing. However, in the above process, since the image fusion model extracts rough image features, it is prone to the loss of information on details in the newly generated image during image generation, which leads to the distortion of an image generation effect, and a poor effect of virtual clothing changing.

### SUMMARY

The embodiments of the present disclosure provide a method, apparatus, device, and storage medium for image generation, which can improve the fidelity of a generated image.

In a first aspect, embodiments of the present disclosure provide a method for image generation, comprising:
obtaining a first human body image comprising a target human body and a first clothing image comprising target clothing;
performing key point extraction, portrait segmentation and human body part segmentation on the first human body image respectively, to obtain a key point feature image, a portrait segmented image and a human body part segmented image;
inputting the key point feature image, the portrait segmented image, the human body part segmented image and the first clothing image into a transformation model, to obtain a transformed second clothing image; and
inputting the second clothing image, the first human body image, the key point feature image, the portrait segmented image and the human body part segmented image into a merging model, to obtain a second human body image, wherein the target human body in the second human body image wears the target clothing.

In a second aspect, embodiments of the present disclosure provide an apparatus for image generation, comprising:
a human body image obtaining module configured to obtain a first human body image comprising a target human body and a first clothing image comprising target clothing;
a segmented image obtaining module configured to perform key point extraction, portrait segmentation and human body part segmentation respectively on the first human body image to obtain a key point feature image, a portrait segmented image and a human body part segmented image;
a second clothing image obtaining module configured to input the key point feature image, the portrait segmented image, the human body part segmented image and the first clothing image into a transformation model, to obtain a transformed second clothing image; and
a second human body image obtaining module configured to input the second clothing image, the first human body image, the key point feature image, the portrait segmented image and the human body part segmented image into a merging model, to obtain a second human body image, wherein the target human body in the second human body image wears the target clothing.

In a third aspect, embodiments of the present disclosure provide an electronic device, comprising:
one or more processing devices;
a memory configured to store one or more programs,
the one or more programs, when executed by the one or more processing devices, cause the one or more processing devices to implement the method for image generation according to the embodiments of the present disclosure.

In a fourth aspect, embodiments of the present disclosure provide a computer-readable storage medium storing a computer program which, when executed by a processing device, implements the method for image generation according to the embodiments of the present disclosure.

### BRIEF DESCRIPTION OF THE DRAWINGS

FIG. 1 is a flowchart of a method for image generation according to an embodiment of the present disclosure;

FIG. 2 is a schematic diagram of a human body image and a clothing image according to an embodiment of the present disclosure;

FIG. 3a is an example diagram of human body key point extraction according to an embodiment of the present disclosure;

FIG. 3b is an example diagram of portrait segmentation according to an embodiment of the present disclosure;

FIG. 3c is an example diagram of human body part segmentation according to an embodiment of the present disclosure;

FIG. 3d is an example diagram of adjusting a first human body image according to an embodiment of the present disclosure;

FIG. 4 is an example diagram of performing transformation processing on target clothing according to an embodiment of the present disclosure;

FIG. 5 is an example diagram of obtaining a clothing-changed human body image according to an embodiment of the present disclosure;

FIG. 6 is a schematic structural diagram of an apparatus for image generation according to an embodiment of the present disclosure; and

FIG. 7 is a schematic structural diagram of an electronic device according to an embodiment of the present disclosure.

### DETAILED DESCRIPTION

It should be understood that a plurality of steps described in the embodiments of the method of the present disclosure may be executed in different sequences and/or in parallel. Furthermore, the embodiments of the method may include additional steps and/or omit to execute shown steps. The scope of the present disclosure is not limited in this aspect.

The term “include” as used herein and its variations are open-ended, meaning “including but not limited to”. The term “based on” means “based at least in part on”. The term “one embodiment” means “at least one embodiment”; the term “another embodiment” means “at least one additional embodiment”; and the term “some embodiments” means “at least some embodiments”. Relevant definitions of other terms are given in the following description.

It should be noted that concepts such as “first” and “second” mentioned in the present disclosure are only used to distinguish different apparatuses, modules or units, and are not used to limit the sequence or interdependence of functions performed by these apparatuses, modules or units.

It should be noted that the modifications of “one” and “a plurality of” mentioned in the present disclosure are indicative rather than restrictive, and those skilled in the art should understand that they should be understood as “one or more” unless expressly indicated otherwise in the context.

The names of messages or information exchanged between the plurality of apparatuses in the embodiments of the present disclosure are used for illustrative purposes only and are not used to limit the scope of the messages or information.

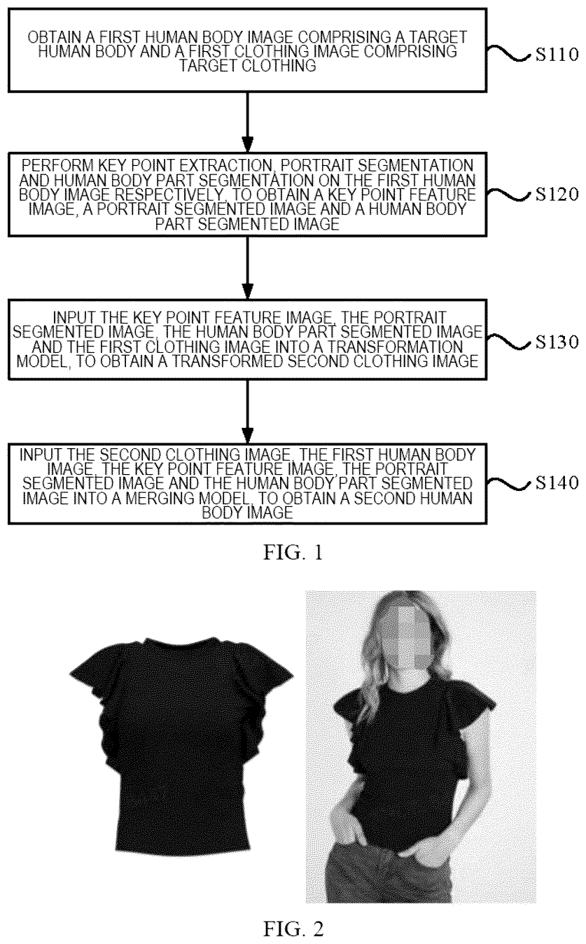

FIG. 1 is a flowchart of a method for image generation according to an embodiment of the present disclosure. The embodiment may be applied to the case of changing clothing of a target person in a human body image. The method may be performed by an apparatus for image generation. The apparatus may be composed of hardware and/or software, and generally may be integrated in a device with an image generation function. The device may be an electronic device such as a server, a mobile terminal, or a server cluster. As shown in FIG. 1, the method includes the following steps:

At step 110, a first human body image comprising a target human body and a first clothing image comprising target clothing are obtained.

The target human body may be a portrait displayed in a certain pose, and the target clothing may be clothing displayed in a plan pattern. As an example, FIG. 2 is a schematic diagram of a human body image and a clothing image. As shown in FIG. 2, on the left side is the first clothing image comprising the target clothing, and on the right side is the first human body image comprising the target human body. In FIG. 2, the target clothing is displayed in a plan pattern.

At step 120, key point extraction, portrait segmentation and human body part segmentation are performed on the first human body image respectively, to obtain a key point feature image, a portrait segmented image and a human body part segmented image.

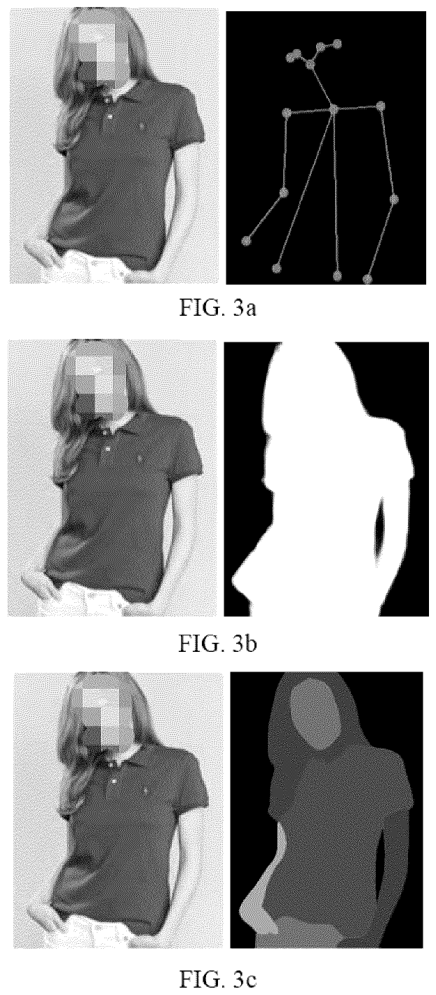

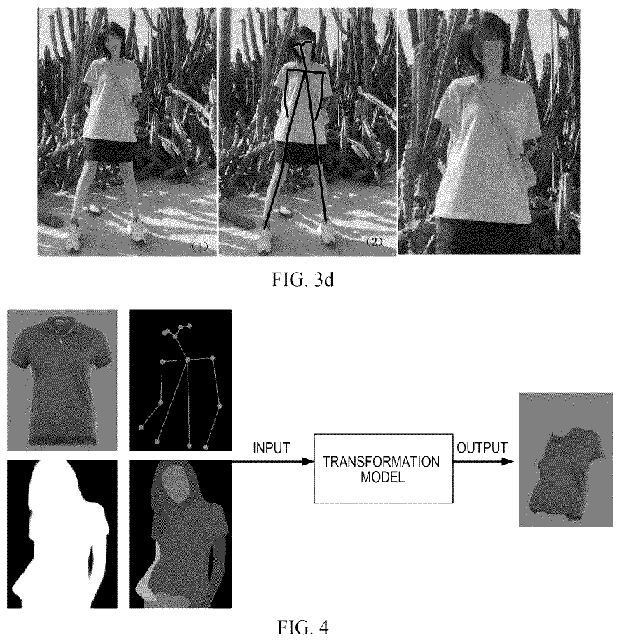

Human body key point extraction may be understood as human body pose estimation. Human body key points may comprise 17 key points, including the nose, left and right eyes, left and right ears, left and right shoulders, left and right elbows, left and right wrists, left and right hips, left and right knees, and left and right ankles. In these embodiments, any human body key point detection algorithm may be adopted to detect the human body key points on the first human body image (not limited here), or the first human body image may be input into a key point extraction model, to obtain a key point feature image. As an example, FIG. 3a is an example diagram of human body key point extraction. As shown in FIG. 3a, on the left side is the obtained first human body image comprising the target human body, and on the right side is the key point feature image. A relative position relationship among the plurality of key points may represent the information on the posture of the human body.

The portrait segmented image may be understood as an image with a portrait segmented from a background. In these embodiments, any portrait segmentation technique may be used to perform portrait segmentation (not limited here), or the first human body image may be input into a portrait segmentation model, to obtain the portrait segmented image. As an example, FIG. 3b is an example diagram of portrait segmentation. As shown in FIG. 3b, on the left side is the obtained first human body image comprising the target human body, and on the right side is the portrait segmented image. It can be seen from FIG. 3b that the portrait segmented image is an image with the portrait segmented from the background.

The human body part segmented image may be understood as an image with a plurality of parts of a human body segmented, for example, an image with a face, hair, arms, an upper body, legs and the like segmented. In these embodiments, any human body part segmentation algorithm may be used to perform human body part segmentation on the first human body image, which is not limited here. Alternatively, the first human body image may be input into a human body part segmentation model, to obtain the human body part segmented image. As an example, FIG. 3c is an example diagram of human body part segmentation. As shown in FIG. 3c, on the left side is the obtained first human body image comprising the target human body, and on the right side is the corresponding human body part segmented image.

In these embodiments, the information on the posture of the human body may be obtained through the key point feature image, the information on the size of the human body may be obtained through the portrait segmented image, and a region that the clothing covers may be obtained through the human body part segmented image. Thus, a posture adjustment can be performed on the clothing image based on the key point feature image, a size adjustment can be performed on the clothing image based on the portrait segmented image, and the clothing image can be cropped based on the human body part segmented image. A transformed clothing image can be obtained after the posture adjustment, size adjustment and cropping are performed on the plan clothing image such that the transformed clothing image fits the current human body in a better way.

For example, after the key point extraction on the first human body image and before the portrait segmentation on the first human body image, the following steps are also included: obtaining reference key point distribution information; and adjusting the key points of the first human body image based on the reference key point distribution information, to obtain an adjusted first human body image.

The reference key point distribution information may be understood as information on the distribution of a plurality of human body key points in a reference image. In these embodiments, after the key points of the first human body image are extracted respectively, the extracted key points are aligned with reference key points, so as to achieve the purpose of adjusting the size of the image and the proportion of the portrait in the image. As an example, FIG. 3d is an example diagram of adjusting the first human body image in these embodiments. Referring to FIG. 3d, the proportion of a human body in an image (1) and the size of the image are inconsistent with a reference image. In this case, key points of the human body in the image (1) are extracted to obtain an image (2), and then the key points in the image (2) are aligned with the reference key points to obtain the adjusted image (3).

The way to perform portrait segmentation and human body part segmentation on the first human body image respectively is to perform the portrait segmentation and the human body part segmentation on the adjusted first human body image respectively.

At step 130, the key point feature image, the portrait segmented image, the human body part segmented image and the first clothing image are input into a transformation model, to obtain a transformed second clothing image.

The transformation model may be obtained by training a configured neural network based on a human body sample image and a clothing sample image, wherein the configured neural network may be a convolutional neural network, etc.

For example, after the key point feature image, the portrait segmented image, the human body part segmented image and the first clothing image are obtained, the key point feature image, the portrait segmented image, the human body part segmented image and the first clothing image are input into the transformation model, to obtain the transformed second clothing image. As an example, FIG. 4 is an example diagram of performing transformation processing on the target clothing in these embodiments.

For example, the process that the key point feature image, the portrait segmented image, the human body part segmented image and the first clothing image are input into the transformation model, to obtain the transformed second clothing image may include: the transformation model performing a posture adjustment on the first clothing image based on the key point feature image, performing a size adjustment on the posture-adjusted clothing image based on the portrait segmented image, and cropping the size-adjusted clothing image based on a clothing region in the human body part segmented image to obtain the transformed second clothing image.

The transformed second clothing image may be obtained after the posture adjustment, size adjustment and cropping are performed on the first clothing image in order based on the key point feature image, the portrait segmented image and the human body part segmented image, which can ensure that the transformed second clothing image fits the current human body in a better way.

In these embodiments, the transformation model may be trained by: obtaining the human body sample image and the clothing sample image, wherein a human body in the human body sample image wears clothing in the clothing sample image; performing key point extraction, portrait segmentation and human body part segmentation on the human body sample image respectively, to obtain a key point feature sample image, a portrait segmented sample image and a human body part segmented sample image; inputting the key point feature sample image, the portrait segmented sample image, the human body part segmented sample image and the clothing sample image into an initial model, to obtain a first transformed clothing image; calculating a loss function based on the first transformed clothing image and the human body sample image; and training the initial model based on the loss function, to obtain the transformation model.

The key point extraction, portrait segmentation and human body part segmentation may also be performed on the human body sample image respectively in such a way that the human body sample image is input into the key point extraction model, the portrait segmentation model and the human body part segmentation model respectively, to obtain the key point feature sample image, the portrait segmented sample image and the human body part segmented sample image.

At step 140, the second clothing image, the first human body image, the key point feature image, the portrait segmented image and the human body part segmented image are input into a merging model, to obtain a second human body image.

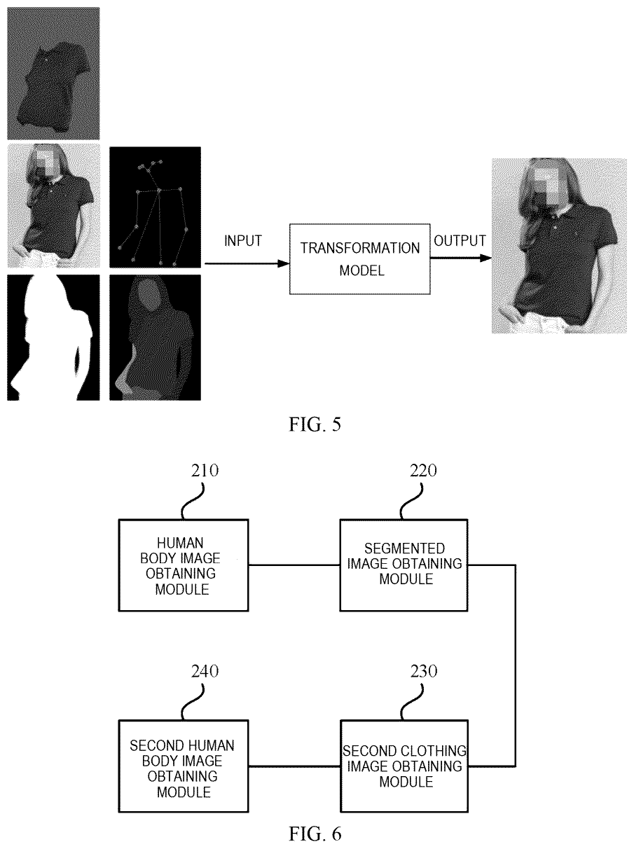

The target human body in the second human body image wears the target clothing. The merging model may be obtained by training a generative model in a generative adversarial network based on the human body sample image and the clothing sample image. For example, the second clothing image, the key point feature image, the portrait segmented image and the human body part segmented image are input into the merging model, to obtain the second human body image. As an example, FIG. 5 is a diagram illustrating an example of obtaining a clothing-changed human body image according to an embodiment of the present disclosure.

For example, the process that the second clothing image, the first human body image, the key point feature image, the portrait segmented image and the human body part segmented image are input into the merging model, to obtain the second human body image may include: the merging model combining the second clothing image and the first human body image to obtain an initial image, optimizing a clothing posture in the initial image based on the key point feature image, optimizing a clothing size in the initial image based on the portrait segmented image, and cropping the clothing in the initial image based on the human body part segmented image to obtain the second human body image.

In these embodiments, since the clothing and the human body in the initial image that is obtained by combining the second clothing image and the first human body image fits each other in a low degree, the initial image needs to be optimized. After the posture optimization, the size optimization and the cropping optimization are performed on the initial image in order based on the key point feature image, the portrait segmented image and the human body part segmented image, the clothing and the human body in the obtained second human body image can fit each other in a better way, to achieve higher fidelity.

In these embodiments, the merging model is trained by: inputting the key point feature sample image, the portrait segmented sample image and the human body part segmented sample image and the clothing sample image into the transformation model, to obtain a second transformed clothing image; inputting the second transformed clothing image, the human body sample image, the key point feature sample image, the portrait segmented sample image, the human body part segmented sample image and the clothing sample image into a generative model, to obtain a generated human body image; inputting the generated human body image into a discriminative model, to obtain a discrimination result; and training the generative model based on the discrimination result, to obtain the merging model.

The merging model is trained based on the transformation model. For example, the accuracy of the final merging model can be improved by performing adversarial training on the generative model and the discriminative model.

According to the technical solution of the embodiments, a first human body image comprising the target human body and a first clothing image comprising the target clothing are obtained; key point extraction, portrait segmentation and human body part segmentation are performed on the first human body image respectively, to obtain a key point feature image, a portrait segmented image and a human body part segmented image; the key point feature image, the portrait segmented image, the human body part segmented image and the first clothing image are input into a transformation model, to obtain a transformed second clothing image; and the second clothing image, the first human body image, the key point feature image, the portrait segmented image and the human body part segmented image are input into a merging model, to obtain the second human body image, wherein the target human body in the second human body image wears the target clothing. According to the method for image generation provided by the embodiments of the present disclosure, the transformed second clothing image is obtained by performing transformation processing on the target clothing in the first clothing image by the transformation model, and the second human body image wearing the target clothing is obtained by mixing the transformed target clothing and the target human body by the merging model, so that the fidelity of the generated image can be increased.

FIG. 6 is a schematic structural diagram of an apparatus for image generation according to an embodiment of the present disclosure. As shown in FIG. 6, the apparatus includes:
a human body image obtaining module 210 configured to obtain a first human body image comprising a target human body and a first clothing image comprising target clothing;
a segmented image obtaining module 220 configured to perform key point extraction, portrait segmentation and human body part segmentation respectively on the first human body image to obtain a key point feature image, a portrait segmented image and a human body part segmented image;
a second clothing image obtaining module 230 configured to input the key point feature image, the portrait segmented image, the human body part segmented image and the first clothing image into a transformation model, to obtain a transformed second clothing image; and
a second human body image obtaining module 240 configured to input the second clothing image, the first human body image, the key point feature image, the portrait segmented image and the human body part segmented image into a merging model, to obtain a second human body image, wherein the target human body in the second human body image wears the target clothing.

For example, the segmented image obtaining module 220 is further configured to:
input the first human body image into a key point extraction model, a portrait segmentation model and a human body part segmentation model respectively, to obtain the key point feature image, the portrait segmented image and the human body part segmented image.

For example, the second clothing image obtaining module 230 is further configured to:
perform, by the transformation model, a posture adjustment on the first clothing image based on the key point feature image;
perform, by the transformation model, a size adjustment on the posture-adjusted clothing image based on the portrait segmented image; and
crop, by the transformation model, the size-adjusted clothing image based on a clothing region in the human body part segmented image, to obtain the transformed second clothing image.

For example, the second human body image obtaining module 240 is further configured to:
combining, by the merging model, the second clothing image and the first human body image to obtain an initial image; and
optimizing a clothing posture in the initial image based on the key point feature image, optimizing a clothing size in the initial image based on the portrait segmented image, and optimizing and cropping clothing in the initial image based on the human body part segmented image to obtain the second human body image.

For example, the apparatus for image generation further comprises: a first human body image adjusting module configured to,
obtain reference key point distribution information; and
adjust key points of the first human body image based on the reference key point distribution information, to obtain an adjusted first human body image.

For example, the segmented image obtaining module 220 is further configured to:
perform portrait segmentation and human body part segmentation on the adjusted first human body image respectively.

For example, the apparatus for image generation further comprises: a transformation model training module configured to,
obtain a human body sample image and a clothing sample image, wherein a human body in the human body sample image wears clothing in the clothing sample image;
perform key point extraction, portrait segmentation and human body part segmentation on the human body sample image respectively, to obtain a key point feature sample image, a portrait segmented sample image and a human body part segmented sample image;
input the key point feature sample image, the portrait segmented sample image, the human body part segmented sample image and the clothing sample image into an initial model, to obtain a first transformed clothing image;
calculate a loss function based on the first transformed clothing image and the human body sample image; and
train the initial model based on the loss function, to obtain the transformation model.

For example, the apparatus for image generation further comprises: a merging model training module configured to,
input the key point feature sample image, the portrait segmented sample image, the human body part segmented sample image and the clothing sample image into the transformation model, to obtain a second transformed clothing image;
input the second transformed clothing image, the human body sample image, the key point feature sample image, the portrait segmented sample image, the human body part segmented sample image and the clothing sample image into a generative model, to obtain a generated human body image;
input the generated human body image into a discriminative model, to obtain a discrimination result; and
train the generative model based on the discrimination result, to obtain the merging model.

For example, the clothing image is a clothing plan image.

The above-described apparatus may perform the method provided by the foregoing embodiments of the present disclosure, and has corresponding functional modules for executing the above-described method, and obtain the beneficial effects. Technical details not described in detail in these embodiments can be found in the method provided by the foregoing embodiments of the present disclosure.

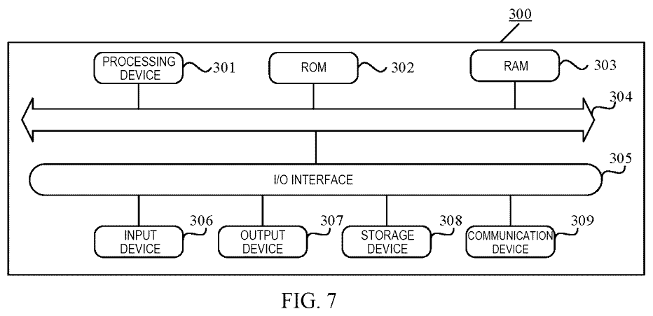

Reference is made below to FIG. 7, which shows a schematic structure diagram suitable for implementing an electronic device 300 according to an embodiment of the present disclosure. The electronic device according to the embodiment of the present disclosure may include, but is not limited to, a mobile terminal such as a mobile phone, a notebook computer, a digital broadcast receiver, a personal digital assistant (PDA), a portable Android device (PAD), a portable multimedia player (PMP), a vehicle-mounted terminal (e.g., a vehicle-mounted navigation terminal), etc., and a fixed terminal such as a digital TV, a desktop computer, etc., or a server in various forms, such as a stand-alone server or a server cluster. The electronic device shown in FIG. 7 is merely an example and should not impose any limitations on the functionality and scope of use of the embodiments of the present disclosure.

As shown in FIG. 7, the electronic device 300 may include a processing device (e.g., a central processing device, a graphics processing device, etc.) 301, which may perform a variety of appropriate actions and processing according to a program stored in a read-only memory (ROM) 302 or a program loaded from a storage device 308 to a random access memory (RAM) 303. A variety of programs and data necessary for the operation of the electronic device 300 are also stored in the RAM 303. The processing device 301, the ROM 302 and the RAM 303 are connected to one another through a bus 304. An input/output (I/O) interface 305 is also connected to the bus 304.

In general, the following apparatuses may be connected to the I/O interface 305: an input device 306, such as a touch screen, a touch pad, a keyboard, a mouse, a camera, a microphone, an accelerometer, a gyroscope, etc.; an output device 307, such as a liquid crystal display (LCD), a speaker, a vibrator, etc.; a storage device 308, such as magnetic tape, a hard disk, etc.; and a communication device 309. The communication device 309 may allow the electronic device 300 to communicate with other devices in a wireless or wired way to exchange data. Although FIG. 7 shows the electronic device 300 having a plurality of devices, it should be understood that the electronic device 300 is not limited to implement or include all of the apparatuses shown. Alternatively, the electronic device 300 may implement or include more or fewer devices.

According to the embodiments of the present disclosure, the process described above with reference to the flowchart may be implemented as a computer software program. For example, the embodiments of the present disclosure include a computer program product comprising a computer program carried on a computer-readable medium. The computer program comprises program codes used for executing a method for recommendation of words. In such an embodiment, the computer program may be downloaded and installed from a network through the communication device 309, or installed from the storage device 308, or installed from the ROM 302. When the computer program is executed by the processing device 301, the above-mentioned functions defined in the method according to the embodiment of the present disclosure are executed.

It should be noted that the computer-readable storage medium mentioned above in the present disclosure may be a computer-readable signal medium or a computer-readable storage medium, or any combination of the two. The computer-readable storage medium may be, but not limited to, for example, an electrical, magnetic, optical, electromagnetic, infrared, or semiconductor-based system, apparatus or device, or any combination thereof. More specific examples of the computer-readable storage medium may include but are not limited to: an electrical connection having one or more conducting wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that comprises or stores a program that may be used by or in combination with an instruction execution system, apparatus or device. In the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may also be any computer-readable medium other than a computer-readable storage medium; and the computer-readable signal medium may send, propagate or transmit a program that is used by or in combination with an instruction execution system, apparatus or device. The program codes that the computer-readable medium comprises may be transmitted by means of any suitable medium, including but not limited to: an electric wire, an optical cable, a radio frequency (RF), etc., or any suitable combination thereof. The computer-readable storage medium may be a non-transient computer-readable storage medium.

In some embodiments, a client and a server may communicate by means of any network protocol that is known at present or developed in the future, such as a hypertext transfer protocol (HTTP), and may be interconnected with digital data communication (e.g., a communication network) of any form or medium. Examples of the communication network include a local area network (LAN), a wide area network (WAN), an internetwork (e.g., the Internet) and an end-to-end network (e.g., an ad hoc end-to-end network), and any networks that are known at present or developed in the future.

The above-mentioned computer-readable medium may be contained in the above-mentioned electronic device, and may also exist independently without being installed in the electronic device.

The above-mentioned computer-readable medium carries one or more programs. When the one or more programs are executed by the electronic device, the electronic device is enabled to implement the following steps: obtaining a first human body image comprising a target human body and a first clothing image comprising target clothing; performing key point extraction, portrait segmentation and human body part segmentation on the first human body image respectively, to obtain a key point feature image, a portrait segmented image and a human body part segmented image; inputting the key point feature image, the portrait segmented image, the human body part segmented image and the first clothing image into a transformation model, to obtain a transformed second clothing image; and inputting the second clothing image, the first human body image, the key point feature image, the portrait segmented image and the human body part segmented image into a merging model, to obtain a second human body image, wherein the target human body in the second human body image wears the target clothing.

Computer program codes for performing the operations of the present disclosure may be written in one or more programming languages or a combination thereof, including object-oriented programming languages such as Java, Smalltalk, C++, etc., and conventional procedural programming languages such as “C” or similar programming languages. The program codes may be executed completely on a user computer, partially on the user computer, as an independent software package, partially on the user computer and partially on a remote computer, or completely on a remote computer or server. In a case involving the remote computer, the remote computer may be connected to the user computer through any type of network, including a LAN or a WAN, or may be connected to an external computer (for example, through the Internet by using an Internet service provider).

The flowchart and block diagram in the accompanying drawings illustrate architectures, functions, and operations that may be realized in accordance with the systems, methods, and computer program products of various embodiments of the present disclosure. In this regard, each block in the flowchart or block diagram may represent a module, a program segment, or part of the codes, which comprises one or more executable instructions for implementing specified logical functions. It should also be noted that in some alternative implementations, functions indicated in the blocks may also be implemented in an order different from that indicated in the drawings. For example, two blocks represented in succession may be executed basically in parallel in fact, and sometimes they may also be executed in reverse order, depending on the function involved. It should also be noted that each block in the block diagram and/or flowchart, as well as a combination of the blocks in the block diagram and/or flowchart, may be implemented with a dedicated hardware-based system that executes a specified function or operation, or with a combination of dedicated hardware and computer instructions.

Units described in the embodiments of the present disclosure may be implemented by means of software or hardware. The names of the units do not limit the units in some cases.

The functions described herein can be executed at least in part by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), etc.

In the context of the present disclosure, a machine-readable medium may be a tangible medium that may comprise or store a program for use by or in combination with an instruction execution system, apparatus or device. The machine-readable storage medium may be a machine-readable signal medium or machine-readable storage medium. The machine-readable medium may be, but not limited to, an electronic, magnetic, optical, electromagnetic, infrared, or semiconductor-based system, apparatus or device, or any combination thereof. More specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the foregoing.

According to one or more embodiments of the present disclosure, embodiments of the present disclosure disclose a method for image generation, comprising:
obtaining a first human body image comprising a target human body and a first clothing image comprising target clothing;
performing key point extraction, portrait segmentation and human body part segmentation on the first human body image respectively, to obtain a key point feature image, a portrait segmented image and a human body part segmented image;
inputting the key point feature image, the portrait segmented image, the human body part segmented image and the first clothing image into a transformation model, to obtain a transformed second clothing image; and
inputting the second clothing image, the first human body image, the key point feature image, the portrait segmented image and the human body part segmented image into a merging model, to obtain a second human body image, wherein the target human body in the second human body image wears the target clothing.

For example, the performing key point extraction, portrait segmentation and human body part segmentation on the first human body image respectively, to obtain the key point feature image, the portrait segmented image and the human body part segmented image comprises:
inputting the first human body image into a key point extraction model, a portrait segmentation model and a human body part segmentation model respectively, to obtain the key point feature image, the portrait segmented image and the human body part segmented image.

For example, the inputting the key point feature image, the portrait segmented image, the human body part segmented image and the first clothing image into the transformation model, to obtain the transformed second clothing image comprises:
performing, by the transformation model, a posture adjustment on the first clothing image based on the key point feature image;
performing, by the transformation model, a size adjustment on the posture-adjusted clothing image based on the portrait segmented image; and
cropping, by the transformation model, the size-adjusted clothing image based on a clothing region in the human body part segmented image, to obtain the transformed second clothing image.

For example, the inputting the second clothing image, the first human body image, the key point feature image, the portrait segmented image and the human body part segmented image into the merging model, to obtain the second human body image comprises:
combining, by the merging model, the second clothing image and the first human body image to obtain an initial image; and
optimizing a clothing posture in the initial image based on the key point feature image, optimizing a clothing size in the initial image based on the portrait segmented image, and optimizing and cropping clothing in the initial image based on the human body part segmented image to obtain the second human body image.

For example, further comprising: after the key point extraction on the first human body image and before the portrait segmentation on the first human body image,
obtaining reference key point distribution information; and
adjusting key points of the first human body image based on the reference key point distribution information, to obtain an adjusted first human body image.

For example, the performing portrait segmentation and human body part segmentation on the first human body image respectively comprises:
performing portrait segmentation and human body part segmentation on the adjusted first human body image respectively.

For example, the transformation model is trained by:
obtaining a human body sample image and a clothing sample image, wherein a human body in the human body sample image wears clothing in the clothing sample image;
performing key point extraction, portrait segmentation and human body part segmentation on the human body sample image respectively, to obtain a key point feature sample image, a portrait segmented sample image and a human body part segmented sample image;
inputting the key point feature sample image, the portrait segmented sample image, the human body part segmented sample image and the clothing sample image into an initial model, to obtain a first transformed clothing image;
calculating a loss function based on the first transformed clothing image and the human body sample image; and
training the initial model based on the loss function, to obtain the transformation model.

For example, the merging model is trained by:
inputting the key point feature sample image, the portrait segmented sample image, the human body part segmented sample image and the clothing sample image into the transformation model, to obtain a second transformed clothing image;
inputting the second transformed clothing image, the human body sample image, the key point feature sample image, the portrait segmented sample image, the human body part segmented sample image and the clothing sample image into a generative model, to obtain a generated human body image;
inputting the generated human body image into a discriminative model, to obtain a discrimination result; and
training the generative model based on the discrimination result, to obtain the merging model.

For example, the clothing image is a clothing plan image.

1-12. (canceled)

13. A method for image generation, comprising:
obtaining a first human body image comprising a target human body and a first clothing image comprising target clothing;
performing key point extraction, portrait segmentation and human body part segmentation on the first human body image respectively, to obtain a key point feature image, a portrait segmented image and a human body part segmented image;
inputting the key point feature image, the portrait segmented image, the human body part segmented image and the first clothing image into a transformation model, to obtain a transformed second clothing image; and
inputting the second clothing image, the first human body image, the key point feature image, the portrait segmented image and the human body part segmented image into a merging model, to obtain a second human body image, wherein the target human body in the second human body image wears the target clothing.

14. The method of claim 13, wherein the performing key point extraction, portrait segmentation and human body part segmentation on the first human body image respectively, to obtain the key point feature image, the portrait segmented image and the human body part segmented image comprises:
inputting the first human body image into a key point extraction model, a portrait segmentation model and a human body part segmentation model respectively, to obtain the key point feature image, the portrait segmented image and the human body part segmented image.

15. The method of claim 13, wherein the inputting the key point feature image, the portrait segmented image, the human body part segmented image and the first clothing image into the transformation model, to obtain the transformed second clothing image comprises:
performing, by the transformation model, a posture adjustment on the first clothing image based on the key point feature image;
performing, by the transformation model, a size adjustment on the posture-adjusted clothing image based on the portrait segmented image; and
cropping, by the transformation model, the size-adjusted clothing image based on a clothing region in the human body part segmented image, to obtain the transformed second clothing image.

16. The method of claim 13, wherein the inputting the second clothing image, the first human body image, the key point feature image, the portrait segmented image and the human body part segmented image into the merging model, to obtain the second human body image comprises:
combining, by the merging model, the second clothing image and the first human body image to obtain an initial image; and
optimizing a clothing posture in the initial image based on the key point feature image, optimizing a clothing size in the initial image based on the portrait segmented image, and optimizing and cropping clothing in the initial image based on the human body part segmented image to obtain the second human body image.

17. The method of claim 13, further comprising: after the key point extraction on the first human body image and before the portrait segmentation on the first human body image,
obtaining reference key point distribution information; and
adjusting key points of the first human body image based on the reference key point distribution information, to obtain an adjusted first human body image.

18. The method of claim 17, wherein the performing portrait segmentation and human body part segmentation on the first human body image respectively comprises:
performing portrait segmentation and human body part segmentation on the adjusted first human body image respectively.

19. The method of claim 13, wherein the transformation model is trained by:
obtaining a human body sample image and a clothing sample image, wherein a human body in the human body sample image wears clothing in the clothing sample image;
performing key point extraction, portrait segmentation and human body part segmentation on the human body sample image respectively, to obtain a key point feature sample image, a portrait segmented sample image and a human body part segmented sample image;
inputting the key point feature sample image, the portrait segmented sample image, the human body part segmented sample image and the clothing sample image into an initial model, to obtain a first transformed clothing image;
calculating a loss function based on the first transformed clothing image and the human body sample image; and
training the initial model based on the loss function, to obtain the transformation model.

20. The method of claim 19, wherein the merging model is trained by:
inputting the key point feature sample image, the portrait segmented sample image, the human body part segmented sample image and the clothing sample image into the transformation model, to obtain a second transformed clothing image;
inputting the second transformed clothing image, the human body sample image, the key point feature sample image, the portrait segmented sample image, the human body part segmented sample image and the clothing sample image into a generative model, to obtain a generated human body image;
inputting the generated human body image into a discriminative model, to obtain a discrimination result; and
training the generative model based on the discrimination result, to obtain the merging model.

21. The method of claim 13, wherein the clothing image is a clothing plan image.

22. An electronic device, comprising:
one or more processing devices;
a memory configured to store one or more programs,
the one or more programs, when executed by the one or more processing devices, cause the one or more processing devices to implement a method for image generation comprising:
obtaining a first human body image comprising a target human body and a first clothing image comprising target clothing;
performing key point extraction, portrait segmentation and human body part segmentation on the first human body image respectively, to obtain a key point feature image, a portrait segmented image and a human body part segmented image;
inputting the key point feature image, the portrait segmented image, the human body part segmented image and the first clothing image into a transformation model, to obtain a transformed second clothing image; and
inputting the second clothing image, the first human body image, the key point feature image, the portrait segmented image and the human body part segmented image into a merging model, to obtain a second human body image, wherein the target human body in the second human body image wears the target clothing.

23. The electronic device of claim 22, wherein the performing key point extraction, portrait segmentation and human body part segmentation on the first human body image respectively, to obtain the key point feature image, the portrait segmented image and the human body part segmented image comprises:
inputting the first human body image into a key point extraction model, a portrait segmentation model and a human body part segmentation model respectively, to obtain the key point feature image, the portrait segmented image and the human body part segmented image.

24. The electronic device of claim 22, wherein the inputting the key point feature image, the portrait segmented image, the human body part segmented image and the first clothing image into the transformation model, to obtain the transformed second clothing image comprises:
performing, by the transformation model, a posture adjustment on the first clothing image based on the key point feature image;
performing, by the transformation model, a size adjustment on the posture-adjusted clothing image based on the portrait segmented image; and
cropping, by the transformation model, the size-adjusted clothing image based on a clothing region in the human body part segmented image, to obtain the transformed second clothing image.

25. The electronic device of claim 22, wherein the inputting the second clothing image, the first human body image, the key point feature image, the portrait segmented image and the human body part segmented image into the merging model, to obtain the second human body image comprises:
combining, by the merging model, the second clothing image and the first human body image to obtain an initial image; and
optimizing a clothing posture in the initial image based on the key point feature image, optimizing a clothing size in the initial image based on the portrait segmented image, and optimizing and cropping clothing in the initial image based on the human body part segmented image to obtain the second human body image.

26. The electronic device of claim 22, wherein the method further comprises: after the key point extraction on the first human body image and before the portrait segmentation on the first human body image,
obtaining reference key point distribution information; and
adjusting key points of the first human body image based on the reference key point distribution information, to obtain an adjusted first human body image.

27. The electronic device of claim 26, wherein the performing portrait segmentation and human body part segmentation on the first human body image respectively comprises:
performing portrait segmentation and human body part segmentation on the adjusted first human body image respectively.

28. The electronic device of claim 22, wherein the transformation model is trained by:
obtaining a human body sample image and a clothing sample image, wherein a human body in the human body sample image wears clothing in the clothing sample image;
performing key point extraction, portrait segmentation and human body part segmentation on the human body sample image respectively, to obtain a key point feature sample image, a portrait segmented sample image and a human body part segmented sample image;
inputting the key point feature sample image, the portrait segmented sample image, the human body part segmented sample image and the clothing sample image into an initial model, to obtain a first transformed clothing image;
calculating a loss function based on the first transformed clothing image and the human body sample image; and
training the initial model based on the loss function, to obtain the transformation model.

29. The electronic device of claim 28, wherein the merging model is trained by:
inputting the key point feature sample image, the portrait segmented sample image, the human body part segmented sample image and the clothing sample image into the transformation model, to obtain a second transformed clothing image;
inputting the second transformed clothing image, the human body sample image, the key point feature sample image, the portrait segmented sample image, the human body part segmented sample image and the clothing sample image into a generative model, to obtain a generated human body image;
inputting the generated human body image into a discriminative model, to obtain a discrimination result; and
training the generative model based on the discrimination result, to obtain the merging model.

30. The electronic device of claim 22, wherein the clothing image is a clothing plan image.

31. A non-transitory computer-readable storage medium storing a computer program which, when executed by a processing device, implements a method for image generation comprising:
obtaining a first human body image comprising a target human body and a first clothing image comprising target clothing;
performing key point extraction, portrait segmentation and human body part segmentation on the first human body image respectively, to obtain a key point feature image, a portrait segmented image and a human body part segmented image;
inputting the key point feature image, the portrait segmented image, the human body part segmented image and the first clothing image into a transformation model, to obtain a transformed second clothing image; and
inputting the second clothing image, the first human body image, the key point feature image, the portrait segmented image and the human body part segmented image into a merging model, to obtain a second human body image, wherein the target human body in the second human body image wears the target clothing.

32. The non-transitory computer-readable storage medium of claim 31, wherein the performing key point extraction, portrait segmentation and human body part segmentation on the first human body image respectively, to obtain the key point feature image, the portrait segmented image and the human body part segmented image comprises:
inputting the first human body image into a key point extraction model, a portrait segmentation model and a human body part segmentation model respectively, to obtain the key point feature image, the portrait segmented image and the human body part segmented image.
